(19) United States
(12) Patent Application Publication
(10) Pub. No.: US 2026/0120152 A1
(43) Pub. Date: Apr. 30, 2026

(54) DIGITAL SPACE DETERMINATION FOR AVAILABILITY QUERIES

(71) Applicant: Walmart Apollo, LLC, Bentonville, AR (US)

(72) Inventors: Sanjoy Bose, Bangalore (IN); Konstantin Shmakov, San Jose, CA (US); Anshul Bansal, Bangalore (IN); Nitish Varshney, Bangalore (IN); Girish Sathyanarayana, Mysore (IN); Arjun KN, Bangalore (IN)

(21) Appl. No.: 18/926,708

(22) Filed: Oct. 25, 2024

(51) Int. Cl. G06Q 30/0241

(52) U.S. Cl. CPC G06Q 30/0277

(57) ABSTRACT

Example implementations relate to digital space allocation determinations. In an example, an availability query for digital space during a predetermined period is received. The availability query includes a set of dimensions. Responsive to receiving the availability query, at least one base query is generated for at least a subset of dimensions of the set of dimensions, a respective quantity of available digital space during the predetermined period is determined for the at least one base query, average demand for digital space for a unit of time is obtained by executing the availability query on historical data, and a quantity of available digital space during the predetermined period is determined based on the average demand for digital space for the unit of time and the respective quantity of available digital space for the at least one base query.

### TECHNICAL FIELD

This application relates generally to digital space allocation, and more particularly, to determining digital space availability for large dimensional queries.

### BACKGROUND

Digital space, such as portions of a webpage, network interface, digital display, or other digital space, may be utilized for display of interface elements on behalf of one or more parties. Digital space may be provided in guaranteed digital space (e.g., an entity is ensured of a specific portion of digital space for a specific time and specific duration) or non-guaranteed digital space (e.g., multiple entities may request a portion of a digital space for a specific time and specific duration that are overlapping). Non-guaranteed digital space may be allocated based on one or more parameters provided by each entity attempting to obtain the non-guaranteed digital space.

Entities that attempt to obtain non-guaranteed digital space must determine how to allocate resources. However, some current systems require allocation of resources on long time horizons, such as up to one year or more before actual usage of the digital space may occur. In order for an entity to determine how to allocate resources, the entity must first determine the quantity of digital space that will be available during the future time period. Digital space availability may be dependent on many factors, which may be provided as high-dimension queries for determination of available digital space. Current systems cannot adequately process high-dimension queries in usable time frames or with usable accuracy.

### BRIEF DESCRIPTION OF THE DRAWINGS

Various examples will be described below with reference to the following figures.

FIG. 1 depicts an example system for digital space availability determination, in accordance with some embodiments.

FIG. 2 depicts an example system for determining a quantity of available digital space and a quantity of selected digital space, in accordance with some embodiments.

FIG. 3 depicts a timing diagram for an example availability query, in accordance with some embodiments.

FIG. 4 depicts a flowchart of an example method for determining digital space availability, in accordance with some embodiments.

FIG. 5 depicts an example system with a machine-readable medium that includes instructions for digital space determination, in accordance with some embodiments.

FIG. 6 depicts an example computer system that implements one or more of the disclosed processes, in accordance with some embodiments.

### DETAILED DESCRIPTION

The disclosed systems and methods enable processing of high-dimensionality queries in useable time frames and with usable accuracy. As discussed in greater detail below, in some embodiments, the generation of base queries from a received high-dimensionality availability query enables usage determinations to be generated at a lower dimensional level that enables more efficient processing (e.g., fewer dimensions to be considered) and further allows for batch processing of base query values prior to receiving a high-dimensional availability query, converting a computationally intensive high-dimensional search into a relatively low-computational cost retrieval process. The use of base queries provides an improvement over prior processes by improving both operation of the underlying system (e.g., through increased computational efficiency by providing for processing of reduced-dimension base queries) and an improvement to digital space usage determinations (e.g., by utilizing base queries to provide a focus on query parameters having a significant impact on usage determinations). Additionally, in some embodiments, an average demand determination may be generated for the received query based on sampling of historical datasets that correlate to the current query. Sampling of historical datasets based on correlation to the current query provides accurate demand determinations for use in future digital space determinations. Sampling of historical datasets to generate the average demand determination based on correlation provides an improvement over prior processes by improving both operation of the underling system (e.g., through increased computational efficiency by relying on relatively inexpensive correlation comparisons to identify historical datasets) and an improvement to digital space usage determinations (e.g., by increasing the overall accuracy of determinations through the use of highly correlated historical datasets to provide higher relevancy determinations). These and other advantages will be apparent from the disclosure herein.

This description of the example embodiments is intended to be read in connection with the accompanying drawings that are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

In various embodiments, a system for determining expected digital space availability and expected selection of digital space is disclosed. The system includes a processor and a non-transitory memory that stores instructions. The instructions, when executed, cause the processor to receive an availability request for use of digital space during a predetermined period, wherein the availability request includes a set of dimensions and, responsive to receiving the availability request, generates at least one base query for at least a subset of dimensions of the set of dimensions. The instructions further cause the processor to determine a respective quantity of available digital space during the predetermined period for the at least one base query, obtain average demand for digital space for a unit of time by executing the at least one base query on historical data, determine a quantity of available digital space during the predetermined period based on the average demand for digital space for the unit of time and the respective quantity of available digital space for the at least one base query, and determine an expected quantity of selected digital space based on the quantity of available digital space for the predetermined period.

In various embodiments, a computer-implemented method is disclosed. The computer-implemented method includes steps of receiving an availability request for use of digital space during a predetermined period, wherein the availability request includes a set of dimensions, and, responsive to receiving the availability request, generating at least one base query for at least a subset of dimensions of the set of dimensions, determining a respective quantity of available digital space during the predetermined period for the at least one base query, obtaining average demand for digital space for a unit of time by executing the at least one base query on historical data, determining a quantity of available digital space during the predetermined period based on the average demand for digital space for the unit of time and the respective quantity of available digital space for the at least one base query, and determining an expected quantity of selected digital space based on the quantity of available digital space for the predetermined period.

In various embodiments, a non-transitory computer-readable medium having instructions stored thereon is disclosed. The instructions, when executed by at least one processor, cause at least one device to perform operations including receiving an availability request for use of digital space during a predetermined period, wherein the availability request includes a set of dimensions and, responsive to receiving the availability request, generating at least one base query for at least a subset of dimensions of the set of dimensions, determining a respective quantity of available digital space during the predetermined period for the at least one base query, obtaining average demand for digital space for a unit of time by executing the at least one base query on historical data, determining a quantity of available digital space during the predetermined period based on the average demand for digital space for the unit of time and the respective quantity of available digital space for the at least one base query, and determining an expected quantity of selected digital space based on the quantity of available digital space for the predetermined period.

Furthermore, in the following, various embodiments are described with respect to methods and systems for determining future availability of digital space. In various embodiments, an availability query for determining availability and usage of digital space in a future time period is received. As one non-limiting example, in some embodiments, the digital space may include online, programmatically generated and displayed digital space, such as digital space within a webpage or other network interface. One or more content providers may provide requests for usage of the digital space on a non-guaranteed basis. That is, the content providers may provide proposals, or bids, for usage of the digital space that include one or more parameters defining the proposed usage. A controlling entity of the digital space, e.g., a website provider, may select a proposal from a content provider that maximizes one or more target parameters. The target parameters may represent limited or consumable resources of the content providers, and the content providers may attempt to maximize the use of the consumable resources by estimating minimum parameters of a usage proposal that will successfully be accepted by the controlling entity.

In some embodiments, the disclosed systems and methods may be utilized to estimate an available quantity of non-guaranteed digital space for one or more digital interfaces during a predetermined time period. A proposed usage including usage parameters and a target time period may be referred to as a campaign (e.g., a content campaign). In some embodiments, each time a user requests a digital interface including a non-guaranteed digital space, the owner or operator of the digital interface may select an instance of a digital campaign from a plurality of digital campaigns competing for usage of the non-guaranteed digital space. Selection of a specific content campaign for inclusion in a digital interface may be referred to as an impression.

In some embodiments, an expected digital space inventory for the future time period and a campaign selection rate for a range of resource allocations for the future time period are determined. The expected digital space inventory and the campaign selection rate are determined based on one or more dimensions of the availability request, such as one or more campaign parameters defined by an availability query. In order to determine availability of digital space, one or more base queries are generated for one or more dimensions of the availability query. Base queries may include a query utilizing a predetermined set of dimensions extracted from the dimensions of the availability query. In some embodiments, the availability query is formatted as a query that defines an exponential number of dimensions having high cardinality (e.g., billions of potential combinations of various predicted values), which are to be executed on a sparse data set. In contrast, each of the base queries is a subset of the dimensions defined by the initial query that may be effectively executed by one or more time-series models. Each of the base queries is executed on historical data to determine future digital space availability based on historical availability, and a total availability for the availability request is determined by combining availabilities for each generated base query.

In some embodiments, after determining expected digital inventory for a campaign time period, a campaign selection rate for a campaign defined by the availability query is determined. The campaign selection rate may indicate a probability (e.g., likelihood) that a corresponding campaign will be selected for instances of a digital interface including digital space during the campaign period. The campaign selection rate may be utilized to adjust campaign parameters to increase or decrease the likelihood of a campaign being selected once deployed.

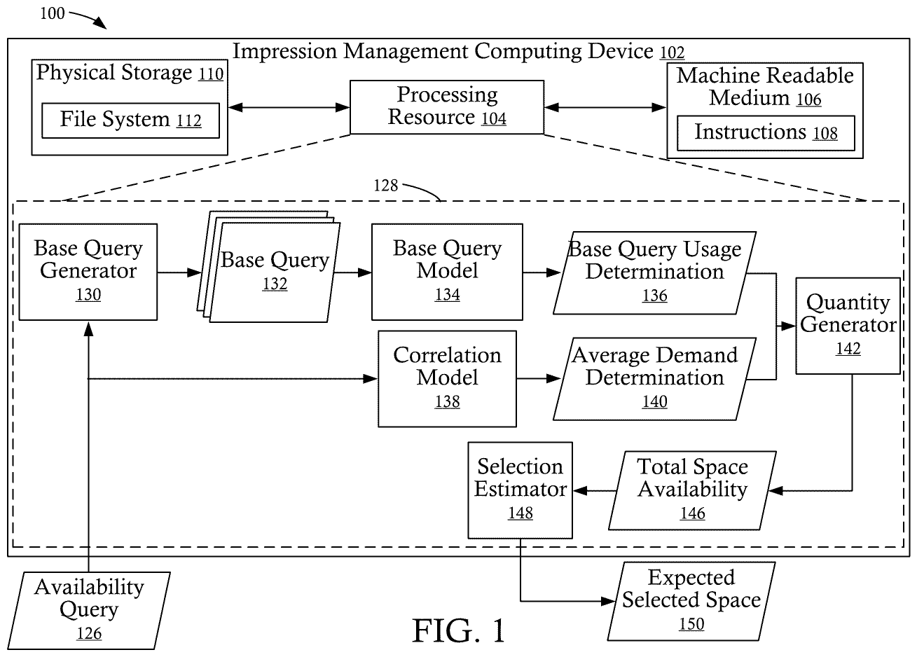

FIG. 1 depicts an example system 100 for digital space availability and usage determinations, in accordance with some embodiments. The system 100 includes an impression management computing device 102 that provides a space availability and campaign selection rate for a future time period based on an availability query. The impression management computing device 102 includes a processing resource 104 that may include one or more microcontrollers, microprocessors, field-programmable gate arrays (FPGAs), application-specific integrated circuits (ASICs), state machines, digital circuitry, and/or any other suitable processing resource. The impression management computing device 102 includes a non-transitory machine-readable medium 106 that may include one or more of a random access memory (RAM), read-only memory (ROM), electrically erasable programmable read-only memory (EEPROM), flash memory, hard disk, and/or any other suitable memory resource.

The processing resource 104 may execute instructions 108 (i.e., programming or software code) stored on machine-readable medium 106 to perform functions of the impression management computing device 102, such as receiving an availability query, generating a set of base queries, executing the base queries to generate base query usage trends, executing the availability query to identify correlation with historical campaigns, and aggregating responses to generate a space availability determination. The instructions 108 may include instructions for implementing one or more models. In some embodiments, and as will be described further herein below, the impression management computing device 102 may execute one or more models, processes, or algorithms, such as a machine learning model, deep learning model, statistical model, etc. (e.g., as implemented as machine-readable instructions) to generate base queries and execute space determinations for each generated base query.

The impression management computing device 102 may also include other hardware components, such as physical storage 110. Physical storage 110 may include any physical storage device, such as a hard disk drive, a solid state drive, or the like, or a plurality of such storage devices (e.g., an array of disks), and may be locally attached (i.e., installed) in the impression management computing device 102. In some implementations, physical storage 110 may be accessed as a block storage device.

In some cases, the impression management computing device 102 may also include a local file system 112 that may be implemented as a layer on top of the physical storage 110. For example, an operating system may be executing on the impression management computing device 102 (by virtue of the processing resource 104 executing certain instructions 108 related to the operating system) and the operating system may provide a file system 112 to store data on the physical storage 110.

In some embodiments, the processing resource 104 implements one or more processes to determine future digital space availability or campaign selection rate, such as an impression process 128. The impression process 128 receives an availability query 126 defining parameters for a proposed future content campaign for a future time period. The parameters may include a set of dimensions defining the proposed usage campaign or aspects of the availability query 126. For example, the availability query 126 may define a set of dimensions including the future time period for the campaign, a targeting definition defining one or more dimensions for the campaign, a total resource allocation for the proposed campaign, a per-selection allocation reduction for the proposed campaign, or any other suitable parameters.

In some embodiments, a targeting definition may define one or more sub-parameters (e.g., dimensions) for determining delivery of digital content, such as contextual sub-parameters (e.g., targeting based on context of digital space interaction), keyword sub-parameters (e.g., targeting based on keywords included in searches or other input), and behavioral sub-parameters (e.g., targeting based on interaction history). The targeting definition may include additional sub-parameters (e.g., dimensions) defining additional aspects for targeting and selection of digital content, such as demographic targeting information, geographic targeting information, platform targeting information, device targeting information, etc.

In some embodiments, the availability query 126 may be provided in the form of a high-dimension query. A simplified example of an availability query may include:

$$( pageType = browse ) \hat{} ( device = mobile ) \hat{} ( productTaxonomy = laptops ) \hat{} ( platform = app ) \hat{} ( country = USA )$$

Availability queries include high dimensionality, highly cardinal queries that are executed on very sparse data (e.g., historical impression data). Execution of availability queries as received results in billions of combinations of various predicate values.

In some embodiments, to compute an expected space availability for an availability query 126 (e.g., an availability query) during the future time period, the availability query 126 is decomposed into two factors, a long term determination for base dimensions and a correlation factor from a high dimensional correlation model generated using historical content requests. The base dimension determinations may be combined with the correlation factor to generate a total space determination, as discussed in greater detail below.

In some embodiments, to reduce the complexity of executing the received availability query 126, and in response to receiving the availability query 126, at least one base query 132 is generated for one or more dimensions of the set of dimensions. The at least one base query 132 is generated by a base query generator 130 that receives the availability query 126 and outputs the at least one base query 132. The at least one base query 132 may be generated by selecting a base dimension space having one or more strong characteristics corresponding to availability of digital space or related to delivery of digital content. As one non-limiting example, in some embodiments, base dimensions for at least one base query 132 may be selected such that the base dimensions have a strong seasonal characteristic (e.g., strongly correlates to a time of year or specific event), stability over time, and frequency of usage in historically implemented campaigns. In some embodiments, two or more base queries 132 may be generated for two or more sets of base dimensions.

In some embodiments, an expected space availability for an arbitrary query Q (e.g., an availability query 126 having dimensional definitions for each available dimension in the set of dimensions) may be represented as:

$$Q ( t ) \sim Q ( h ) * b ( t )$$

where Q (t) denotes expected space availability for the query Q at day t, Q (h) is the average daily content requests from historical content requests, and b (t) denotes a long-term determination for a base query normalized using historical content requests. In some embodiments, a future correlation factor is approximated using a constant correlation factor that is determined from historical content requests in a high dimensional space (e.g., the dimensional space defined by query Q). The correlation factor may be determined by a high-dimensional correlation model 138.

In some embodiments, the at least one base query 132 is provided to a base query model 134 that generates base query usage determinations (e.g., base query usage trends) for the at least one base query 132 over a predetermined time period. The base query model 134 may include a time-series model that receives the at least one base query 132 and generates one or more base query usage determinations 136 for usage of digital content for a predetermined time period. For example, in some embodiments, the time-series model utilizes data augmentation, missing value imputation, and outlier detection in conjunction with deep learning processes such as temporal fusion transformers (TFT), trained time-series prediction models (e.g., Prophet, ARIMA, etc.), and statistical models to output usage trend determinations for the at least one base query 132. In some embodiments, the time-series model is an ensemble model (e.g., an ensemble model including a time-series prediction model, a temporal fusion transformer model, and a statistical model) and a subset of the available models is selected based on parameters of the availability query 126.

In some embodiments, base query usage determinations 136 may be generated as a batch (e.g., offline) process during a first time period and stored in a data store for retrieval during a second time period (e.g., when an availability query 126 is received). The base query usage determinations 136 may be generated periodically for a predetermined future time period (e.g., determined once a day for a one-year period) and updated within the data store for use in expected space determinations performed during a subsequent time period (e.g., a next day). It will be appreciated that the base query usage determinations 136 may be generated periodically for any selected period and for any future time period.

The generation of at least one base query 132 from a received high-dimensionality availability query 126 enables usage determinations to be generated at a lower dimensionality that enables more efficient processing (e.g., fewer dimensions to be considered) and further allows for batch processing of base query values prior to receiving a high-dimensional availability query 126, converting a computationally intensive high-dimensional process into a relatively low-computational cost retrieval process. The use of the at least one base query 132 provides an improvement over prior processes by improving both operation of the underlying system (e.g., through increased computational efficiency by providing for processing of the reduced-dimension base query 132) and an improvement to digital space usage determinations (e.g., by utilizing a base query 132 to provide a focus on query parameters having a significant impact on usage determinations).

In addition to the base query usage determinations 136, an average demand determination 140 is generated for the availability query 126. In some embodiments, the availability query 126 is provided to a correlation model 138 that generates (e.g., obtains) an average demand for digital space for a unit of time by executing an availability query on a historical dataset and identifying a correlation value for the historical dataset. In some embodiments, the average demand includes a range of values, e.g., a set of historically available digital space obtained at a range of resource allocation values. The set of historically available digital space may include one or more historical datasets within the range. The historical dataset(s) includes data for historically implemented content campaigns, including dimensions of the historically implemented content campaigns and parameters coinciding with the historically implemented content campaigns. For example, in some embodiments, the parameters include information related to a quantity of available digital space (e.g., digital space slots) during the campaign period of the historically implemented content campaign, a quantity of selected digital space (e.g., selected digital space slots) for the content campaign, results (e.g., interaction data) for the content campaign, or any other suitable historical data.

In some embodiments, the average demand determination 140 is a correlation factor determined through sampling and application of a correlation model 138. Sampling may be implemented to maximize accuracy by minimizing errors for all queries evaluated within a sample dataset and/or to minimize the size of the sampled dataset to evaluate an availability query Q within a predetermined latency (e.g., execution) time. In some embodiments, sampling of the historically implemented content campaign data, and generation of the correlation factor, may be implemented as a Stratified Sampling process based on user sampling and optimized based on historical content campaigns.

Sampling of historical datasets based on correlation to a received availability query 126 provides an accurate average demand determination 140 for use in expected digital space availability determinations. Sampling the set of historically available digital space to generate the average demand determination 140 based on correlation provides an improvement over prior processes by improving both operation of the underling system (e.g., through increased computational efficiency by relying on a relatively computational inexpensive correlation model 138 to identify historically available digital space) and an improvement to digital space usage determinations (e.g., by increasing the overall accuracy of determinations through the use of highly correlated historically available digital space to provide higher relevancy determinations).

The base query usage determinations 136 and the average demand determination 140 are provided to a quantity generator 142 to determine a total expected digital space availability 146, e.g., a quantity of available space that is expected (e.g., predicted) to be available during the campaign period provided in the availability query 126. The quantity generator 142 may combine the base query usage determinations 136 with the average demand determination 140 (e.g., a correlation factor) to determine correlation between the base query usage determinations 136 (e.g., the base query usage trends) and the historical campaign data.

In some embodiments, the total expected digital space availability 146 is used for one or more additional processes, such as, for example, determining an expected quantity of selected digital space 150 for the corresponding campaign represented by the availability query 126. The total expected digital space availability 146 may be provided to a selection estimator 148 that determines an expected quantity of selected digital space 150, e.g., a quantity of digital space expected to be allocated to the campaign represented by the availability query 126 during the campaign period.

In some embodiments, the expected quantity of selected digital space 150 is generated based on the total expected digital space availability 146 and a selection probability, which may be represented as:

$$I ( b , t ) = Total\_Digital \_Space ( t ) * Selection\_Probability ( b , t )$$

where b is an instance of the proposed usage campaign, t is the determination time period, I is the expected quantity of selected digital space 150, Total_Digital_Space(t) is the determined total expected digital space availability 146 for the time period t defined in the availability query 126, and Selection_Probability(b, t) is the likelihood of the proposed campaign being selected for a given slot.

In some embodiments, the Selection_Probability(b, t) may be determined using a generative process, a discriminative process, or any other suitable process. A generative process may include a process for learning a cumulative distribution function (CDF) of resource parameters for past selected proposals. A generative process may include, but is not limited to, processes that assume data distribution on historical data, such as a log normal distribution, for smoothening of a model. A discriminative process may include a learned classifier to directly generate a selection probability as a function of the input parameters. In some embodiments, a discriminative process, or model, may assume the selection probability is a non-decreasing function of a resource parameter for a fixed time duration of the campaign period. In some embodiments, an optimal determination for the selection probability is generated by an inference decision-maker, which identifies an optimal model among available generative and discriminative models for the campaign duration t and the base query B.

In some embodiments, the selection estimator 148 implements a selection probability model that generates the Selection_Probability(b, t). For example, the selection probability model may apply generative and/or discriminative processes that are combined through an ensemble process to identify a most optimal model for each base query generated from an availability query 126. In some embodiments, the selection estimator 148 implements a proposal density estimator to detect overlap between multiple potential proposals from multiple third parties and to provide a higher-precision decision for selected proposals for campaign targeting.

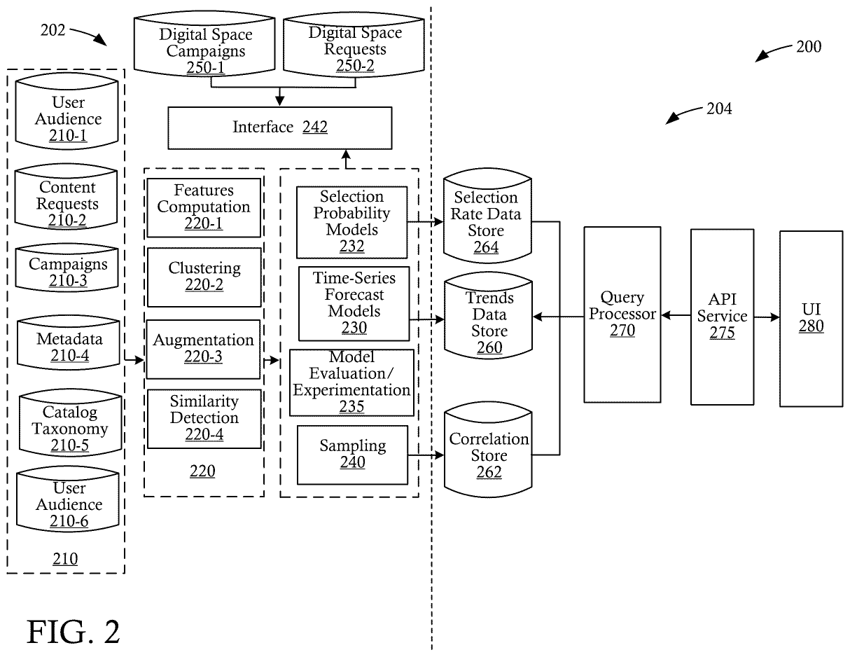

FIG. 2 depicts an example system 200 for determining a quantity of available digital space and a quantity of selected digital space, in accordance with some embodiments. The system 200 includes a first portion 202 that executes at a first time and a second portion 204 that executes at a second time. The first portion 202 may include a batch, or offline, processing portion that receives historical data from a plurality of historical data sources 210-1-210-6 (collectively “data sources 210”). The historical data may be received by one or more data ingestion and preprocessing elements, such as a features computation element 220-1, a clustering element 220-2, an augmentation element 220-3, and a similarity detection element 220-4 (collectively “data ingestion and preprocessing elements 220”).

In some embodiments, the historical data received from the historical data stores 210 is processed by the data ingestion and preprocessing elements 220 for use in one or more digital space determination processes. For example, in some embodiments, the processed historical data is provided to a time-series trend model 230 for determining base query usage determinations (e.g., usage trends), for example, as discussed above with respect to FIG. 1. The time-series trend model 230 may receive input from an interface framework 242 that is in communication with a campaign store 250-1 and a digital space request store 250-2. The time-series trend model 230 may store digital space usage trend determinations in a trend data store 260.

In some embodiments, a model evaluation module 235 is implemented to select a model such as a time-series model or stratified sampling model, for implementation. The model evaluation module 235 identifies a most optimal model for implementation. The most optimal model may be selected based on, for example, parameters of an availability query received via one or more interfaces, such as query processor 270 discussed in greater detail below.

In some embodiments, a sampling model 240 performs stratified sampling of historical data to generate a correlation value for a current campaign with respect to the historical data received from the historical data stores 210. The sampling model 240 generates a correlation value and may, in some embodiments, store the correlation value in a correlation store 265. In some embodiments, a sampling model 240 may be selected by the model evaluation module 235.

In some embodiments, the second portion 204 of the system 200 includes an application programming interface (API) service 275 that receives an input via a user interface 280 from a user, such as a user interacting with a user device that provides the user interface 280. The API service 275 receives data via the user interface 280, such as, for example, an availability query, and provides the availability query to a query processor 270. The query processor 270 generates one or more base queries from the received availability query and executes the one or more base queries to obtain base query trend data from the trend data store 260. The query processor 270 may additionally execute the received availability query to obtain correlation data from the correlation store 262. In some embodiments, the query processor 270 generates a total space availability determination for the received availability query by combining the base query trend data and the correlation data, for example, as discussed above with respect to FIG. 1.

In some embodiments, the query processor 270 utilizes the total space availability determination to generate an expected quantity of selected digital space. The query processor 270 may utilize a selection probability 232 generated by a selection probability model and stored in a selection rate data store 264. The selection probability 232 may be generated by a generative model and/or a discriminative model. In some embodiments, the selection probability 232 is generated by a plurality of models, and the model evaluation module 235 determines which of the plurality of selection probability models 232 (e.g., which of an available ensemble) to apply for a given selection probability determination.

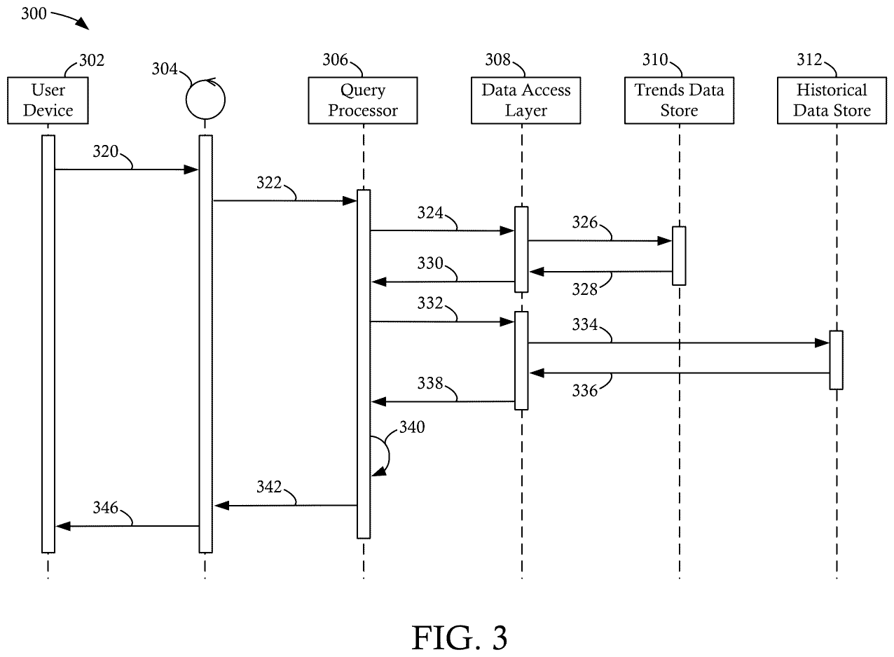

FIG. 3 depicts a timing diagram 300 for an example availability query, in accordance with some embodiments. At a first time, a user device 302 generates 320 an API request to an impression management system (IMS) API 304. The IMS API 304 receives the API request and generates 322 an availability query that is provided to a query processor 306. The query processor 306 generates one or more base queries and provides 324 the base queries to a data access layer 308, which obtains 326 trend data from a trend data store 310 for each base query for a time period T. The trend data is provided 328 to the data access layer 308, which provides 330 trend data for each base query to the query processor 306.

The query processor 306, simultaneously or sequentially, generates 332 a sample request for the generated availability query, which is provided to the data access layer 308. The data access layer samples 334 a historical data store 312 for the time period T and receives 336 sample weights for the availability query. The data access layer provides 338 the weights for the query to the query processor 306, which generates 340 an expected quantity of selected digital space, for example, as discussed above with respect to FIGS. 1 and 2. The query processor 306 provides 342 the expected quantity of selected digital space to the IMS API 304, which transmits 344 the expected quantity of selected digital space to the user device 302.

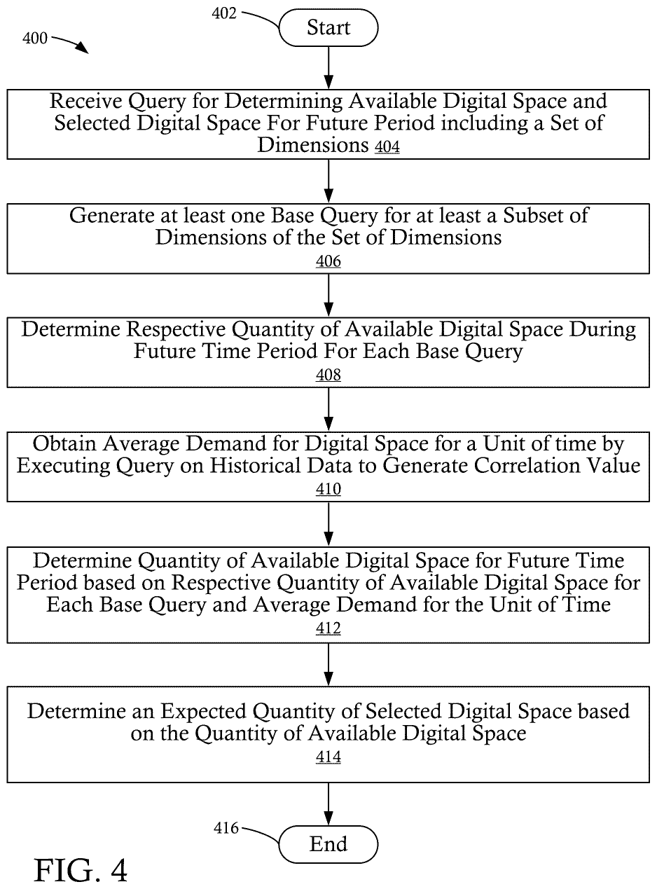

FIG. 4 is a flow diagram depicting an example method. In some embodiments, one or more blocks of the method may be executed substantially concurrently and/or in a different order than shown. In some implementations, a method may include more or fewer blocks than are shown. In some implementations, one or more of the blocks of a method may, at certain times, be ongoing and/or may repeat. In some implementations, blocks of the method may be combined.

The method shown in FIG. 4 may be implemented in the form of executable instructions stored on a machine-readable media and executed by a processing resource and/or in the form of electronic circuitry. For example, aspects of the method may be described below as being performed by an estimation process, an example of which may be the impression process 128 running on a hardware processing resource 104 of the impression management computing device 102 described above. Additionally, other aspects of the method described below may be described with reference to other elements shown in FIG. 1 for non-limiting illustration purposes.

FIG. 4 depicts a flowchart of an example method 400 for determining digital space availability, in accordance with some embodiments. Method 400 starts at block 402 and continues to block 404, where a query for predicting a quantity of available digital space for a future time period is received. The query includes a set of dimensions. For example, the query may define a set of dimensions including the future time period for the campaign, a targeting definition defining one or more dimensions for the campaign, a total resource allocation for the proposed campaign, a per-selection allocation reduction for the proposed campaign, or any other suitable parameters.

At block 406, at least one base query is generated from the query for at least a subset of dimensions in the set of dimensions. The at least one base query may be generated for a set of base dimensions such that the base dimensions have a strong seasonal characteristic (e.g., strongly correlates to a time of year or specific event), stability over time, and frequency of usage in historically implemented campaigns. In some embodiments, two or more base queries 132 may be generated for two or more sets of base dimensions. The base queries or the base dimensions may be predetermined.

At block 408, a respective quantity of available digital space during the future time period is determined for each base query. In some embodiments, the respective quantity of available digital space for a base query is expressed as digital space trend data indicating a usage trend of corresponding digital space over the future time period. In some embodiments, the respective quantity of available digital space for a base query is expressed as an absolute quantity of expected available digital space for the base query.

At block 410, an average demand for digital space for a unit of time is obtained by executing the received query on historical data to generate a correlation value. The average demand may be a correlation factor determined through sampling and application of a correlation model to the historical data. Sampling may be implemented to maximize accuracy by minimizing errors for all queries evaluated within a sample dataset and/or to minimize the size of the sampled dataset to evaluate an availability query Q within a predetermined latency (e.g., execution) time. In some embodiments, sampling of the historically implemented content campaign data, and generation of the correlation factor, may be implemented as a Stratified Sampling process based on user sampling and optimized based on historical content campaigns.

At block 412, a quantity of available digital space for a future time period is determined based on the respective quantity of available digital space for each base query and the average demand for the unit of time. For example, the respective quantity of available digital space for a future time period may be combined with the average demand for the unit of time to determine correlation between available space for the base query and the historical campaign data, providing an expected available space for the future time period of the query.

At block 414, an expected quantity of selected digital space is determined based on the quantity of available digital space for a future time period. In some embodiments, a selection probability may be determined and applied to the quantity of available digital space to generate the expected quantity of selected digital space. The selection probability may be generated by one or more of a generative process, a discriminatory process, or a combination thereof. In some embodiments, the selection probability may be pre-generated and obtained from one or more probability data stores. At block 416, the method 400 ends.

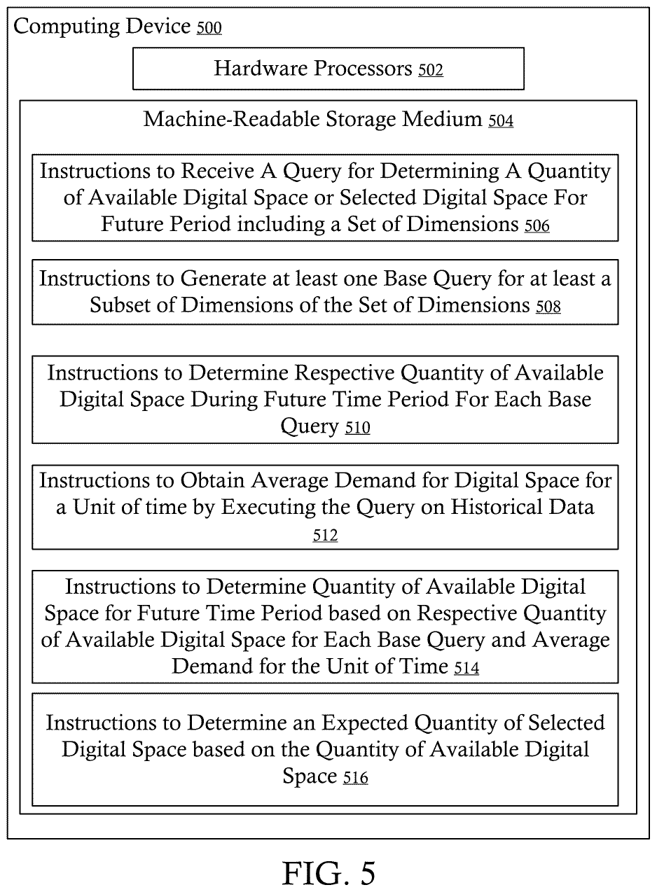

FIG. 5 depicts an example system 500 for digital space determination that includes a machine-readable media 504 encoded with example instructions executable by processing resource 502. In some implementations the system 500 may be useful for implementing aspects of the system 100 of FIG. 1 or performing the aspects of method 400 of FIG. 4. For example, the instructions encoded on machine-readable media 504 may be included in instructions 108 of FIG. 1. In some implementations, functionality described with respect to FIG. 1 may be included in the instructions encoded on machine-readable media 504.

The processing resource 502 may include a microcontroller, a microprocessor, central processing unit core(s), an ASIC, an FPGA, and/or other hardware device suitable for retrieval and/or execution of instructions from the machine-readable media 504 to perform functions related to various examples. Additionally or alternatively, the processing resource 502 may include or be coupled to electronic circuitry or dedicated logic for performing some or all of the functionality of the instructions described herein.

The machine-readable media 504 may be any medium suitable for storing executable instructions, such as RAM, ROM, EEPROM, flash memory, a hard disk drive, an optical disc, or the like. In some example implementations, the machine-readable media 504 may be a tangible, non-transitory medium. The machine-readable media 504 may be disposed within the system 500 in which case the executable instructions may be deemed installed or embedded on the system. Alternatively, the machine-readable media 504 may be a portable (e.g., external) storage medium, and may be part of an installation package.

As described further herein below, the machine-readable media 504 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 5.

The machine-readable media 504 includes instructions 506-516. Instructions 506, when executed, cause the processing resource 502 to receive a query for determining an expected quantity of available digital space or an expected quantity of selected digital space for a future time period. The instructions 508, when executed, cause the processing resource 502 to generate at least one base query for a subset of dimensions of the set of dimensions.

Instructions 510, when executed, cause the processing resource 502 to determine a respective quantity of available digital space during the future time period for each base query. The respective quantity of available digital space may include a digital space usage trend for the base query or an absolute quantity of digital space for the base query. The instructions 512, when executed, cause the processing resource 502 to obtain an average demand for digital space for a unit of time by executing the query on historical data. The average demand may include a correlation factor that is generated through Stratified sampling and application of a trained correlation model.

The instructions 514, when executed, cause the processing resource 502 to determine a quantity of available digital space for the future time period based on the respective quantity of available digital space for each base query and the average demand for the unit of time. The respective quantity of available digital space for each base query and the average demand for the unit of time may be combined by applying a correlation factor of the average demand to the respective quantity of available digital space.

Instructions 516, when executed, cause the processing resource 502 to determine an expected quantity of selected digital space based on the quantity of available digital space. A selection probability may be determined and applied to the quantity of available digital space to generate the expected quantity of selected digital space. The selection probability may be generated by one or more of a generative process, a discriminatory process, or a combination thereof.

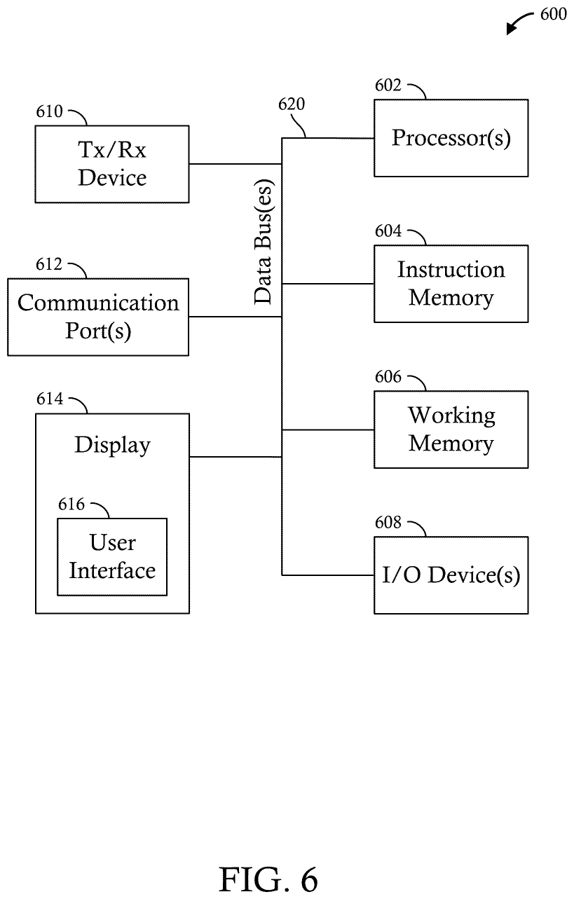

FIG. 6 illustrates a block diagram of a computing device 600, in accordance with some embodiments. Although FIG. 6 is described with respect to certain components shown therein, it will be appreciated that the elements of the computing device 600 may be combined, omitted, and/or replicated. In addition, it will be appreciated that additional elements other than those illustrated in FIG. 6 may be added to the computing device.

As shown in FIG. 6, the computing device 600 may include one or more processing resources 602, instruction memory 604, working memory 606, input/output devices 608, transceiver 610, communication port(s) 612, display 614, and/or any other suitable elements each operatively coupled to one or more data buses 620. The data buses 620 allow for communication among the various components. The data buses 620 may include wired or wireless communication channels.

The one or more processing resources 602 may include any processing circuitry operable to control operations of the computing device 600. In some embodiments, the one or more processing resources 602 include one or more distinct processors, each having one or more cores (e.g., processing circuits). Each of the distinct processors may have the same or different structure. The one or more processing resources 602 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processing resources 602 may also be implemented by a controller, a microcontroller, an application specific integrated circuit (ASIC), a field programmable gate array (FPGA), a programmable logic device (PLD), etc.

In some embodiments, the one or more processing resources 602 implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 604 may store instructions that are accessed (e.g., read) and executed by at least one of the one or more processing resources 602. For example, the instruction memory 604 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processing resources 602 may perform a certain function or operation by executing code, stored on the instruction memory 604, embodying the function or operation. For example, the one or more processing resources 602 may execute code stored in the instruction memory 604 to perform one or more of any function, method, or operation disclosed herein.

Additionally, the one or more processing resources 602 may store data to, and read data from, the working memory 606. For example, the one or more processing resources 602 may store a working set of instructions to the working memory 606, such as instructions loaded from the instruction memory 604. The one or more processing resources 602 may also use the working memory 606 to store dynamic data created during one or more operations. The working memory 606 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 604 and working memory 606, it will be appreciated that the computing device 600 may include a single memory unit that operates as both instruction memory and working memory. Further, although embodiments are discussed herein including non-volatile memory, it will be appreciated that computing device 600 may include volatile memory components in addition to at least one non-volatile memory component.

In some embodiments, the instruction memory 604 and/or the working memory 606 includes an instruction set, in the form of a file for executing various methods, such as methods for determining an expected quantity of available digital space or an expected quantity of selected digital space, as described herein. The instruction set may be stored in any acceptable form of machine-readable instructions, including source code or various appropriate programming languages. Some examples of programming languages that may be used to store the instruction set include, but are not limited to, Java, JavaScript, C, C++, C#, Python, Objective-C, Visual Basic, .NET, HTML, CSS, SQL, NoSQL, Rust, Perl, etc. In some embodiments a compiler or interpreter converts the instruction set into machine executable code for execution by the one or more processing resources 602.

The input/output devices 608 may include any suitable device that allows for data input or output. For example, the input/output devices 608 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 610 and/or the communication port(s) 612 allow for communication with a network. For example, if a communication network is a cellular network, the transceiver 610 allows communications with the cellular network. In some embodiments, the transceiver 610 is selected based on the type of communication network the computing device 600 will be operating in. The one or more processing resources 602 are operable to receive data from, or send data to, a network, via the transceiver 610.

The communication port(s) 612 may include any suitable hardware, software, and/or combination of hardware and software that is capable of coupling the computing device 600 to one or more networks and/or additional devices. The communication port(s) 612 may be arranged to operate with any suitable technique for controlling information signals using a desired set of communications protocols, services, or operating procedures. The communication port(s) 612 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 612 allows for the programming of executable instructions in the instruction memory 604. In some embodiments, the communication port(s) 612 allow for the transfer (e.g., uploading or downloading) of data, such as machine learning model training data.

In some embodiments, the communication port(s) 612 couples the computing device 600 to a network. The network may include local area networks (LAN) as well as wide area networks (WAN) including, without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 610 and/or the communication port(s) 612 utilize one or more communication protocols. Examples of wired protocols may include, but are not limited to, Universal Serial Bus (USB) communication, RS-232, RS-422, RS-423, RS-485 serial protocols, Fire Wire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 614 may be any suitable display, and may display the user interface 616. The display 614 may include a screen such as, for example, a Liquid Crystal Display (LCD) screen, a light-emitting diode (LED) screen, an organic LED (OLED) screen, a movable display, a projection, etc. In some embodiments, the display 614 may include a coder/decoder, also known as Codecs, to convert digital media data into analog signals. For example, the visual peripheral output device may include video Codecs, audio Codecs, or any other suitable type of Codec.

In some embodiments, the computing device 600 implements one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality that (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular example implementation herein, unless such limitations are expressly called out. In addition, a module/engine may itself be composed of more than one sub-module or sub-engine, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

In some embodiments, the computing device 600 may be a computer, a workstation, a laptop, a server such as a cloud-based server, or any other suitable device. In some embodiments, the computing device 600 is a server that includes one or more processing units, such as one or more graphical processing units (GPUs), one or more central processing units (CPUs), and/or one or more processing cores. The computing device 600 may, in some embodiments, execute one or more virtual machines. In some embodiments, processing resources (e.g., capabilities) of the computing device 600 are offered as a cloud-based service (e.g., cloud computing).

Although embodiments are illustrated herein including certain systems and/or devices, it will be appreciated that additional systems, servers, storage mechanisms, etc. may be included. In addition, although embodiments are illustrated herein having individual, discrete systems, it will be appreciated that, in some embodiments, one or more systems may be combined into a single logical and/or physical system. Similarly, although embodiments are illustrated having a single instance of each device or system, it will be appreciated that additional instances of a device may be implemented. In some embodiments, two or more systems may be operated on shared hardware in which each system operates as a separate, discrete system utilizing the shared hardware, for example, according to one or more virtualization schemes.

In some embodiments, the disclosed systems and methods may be used for digital space determinations in the form of digital advertising determinations for managing inventory of non-guaranteed (e.g., auctioned) digital space. Digital advertising campaigns may be targeted at non-guaranteed digital spaces included in participating websites or other digital spaces. A digital space determination may be implemented to determine an expected quantity of advertising impressions (e.g., winning impressions) based on proposed factors for the corresponding auction of the non-guaranteed space. The disclosed systems and methods enable high quality determinations for expected digital space usage to be generated to allow advertisers to manage their allocation of resources for an inventory of advertisements for an available inventory of digital space.

It will be appreciated that determinations for expected available digital space or expected selected digital space as disclosed herein, particularly on large campaign sets intended to be used in network environments, is only possible with the aid of computer-assisted machine-learning algorithms and techniques. In some embodiments, machine learning processes including correlation processes, time-series process, and estimation processes are used to perform operations that cannot practically be performed by a human, either mentally or with assistance.

Although the subject matter has been described in terms of example embodiments, it is not limited thereto. Rather, the appended claims should be construed broadly, to include other variants and embodiments that may be made by those skilled in the art.

1. A system, comprising:
a processor; and
a non-transitory memory storing instructions, that when executed, cause the processor to:
receive, from a user device and via an application programming interface, an availability query for digital space during a predetermined period, wherein the availability request includes a set of dimensions;
responsive to receiving the availability query:
generate at least one base query for a subset of dimensions of the set of dimensions based on a set of base dimensions that are correlated with an availability of digital space during the predetermined period;
input the at least one base query to a base query model and generate a respective quantity of available digital space during the predetermined period for the at least one base query;
obtain average demand for digital space for a unit of time by executing the availability query on historical data; and
determine a quantity of available digital space during the predetermined period based on the average demand for digital space for the unit of time and the respective quantity of available digital space for the availability query; and
transmit the quantity of available digital space to the user device via the application programming interface.

2. The system of claim 1, wherein the instructions, when executed, cause the processor to determine a correlation factor based on an average demand for digital space for the unit of time calculated for a query of the availability request and average demand for digital space for the unit of time calculated for the at least one base query.

3. The system of claim 1, wherein executing the at least one base query on historical data comprises performing stratified sampling of the historical data to evaluate the query.

4. The system of claim 1, wherein the instructions, when executed, cause the processor to determine an expected quantity of selected digital space using the quantity of available digital space during the predetermined period for the at least one base query and a selection probability for the predetermined period.

5. The system of claim 4, wherein the selection probability for the predetermined period is determined based on a correlation factor.

6. The system of claim 1, wherein the respective quantity of available digital space for the at least one base query is determined at a first time based on usage trends determined at a first time.

7. The system of claim 6, wherein the usage trends are determined using a plurality of time-series models.

8. A computer-implemented method, comprising:
receiving, from a user device and via an application programming interface, an availability query for digital space during a predetermined period, wherein the availability query includes a set of dimensions;
responsive to receiving the availability query:
generating at least one base query for a subset of dimensions of the set of dimensions based on a set of base dimensions that are correlated with an availability of digital space during the predetermined period;
inputting the at least one base query to a base query model and generating a respective quantity of available digital space during the predetermined period for the at least one base query;
obtaining average demand for digital space for a unit of time by executing the availability query on historical data; and
determining a quantity of available digital space during the predetermined period based on the average demand for digital space for the unit of time and the respective quantity of available digital space for the at least one base query; and
transmitting the quantity of available digital space to the user device via the application programming interface.

9. The computer-implemented method of claim 8, comprising determining a correlation factor based on an average demand for digital space for the unit of time calculated for a query of the availability request and average demand for digital space for the unit of time calculated for the at least one base query.

10. The computer-implemented method of claim 8, wherein executing the at least one base query on historical data comprises performing stratified sampling of the historical data to evaluate the query.

11. The computer-implemented method of claim 8, comprising determining an expected quantity of selected digital space using the quantity of available digital space during the predetermined period for the at least one base query and a selection probability for the predetermined period.

12. The computer-implemented method of claim 11, wherein the selection probability for the predetermined period is determined based on a correlation factor.

13. The computer-implemented method of claim 8, wherein the respective quantity of available digital space for the at least one base query is determined at a first time based on usage trends determined at a first time.

14. The computer-implemented method of claim 13, wherein the usage trends are determined using a plurality of time-series models.

15. A non-transitory computer-readable medium having instructions stored thereon, wherein the instructions, when executed by at least one processor, cause at least one device to perform operations comprising:
receiving, from a user device and via an application programming interface, an availability query for digital space during a predetermined period, wherein the availability query includes a set of dimensions;
responsive to receiving the availability query:
generating at least one base query for a subset of dimensions of the set of dimensions based on a set of base dimensions that are correlated with an availability of digital space during the predetermined period;
inputting the at least one base query to a base query model and generating a respective quantity of available digital space during the predetermined period for the at least one base query;
obtaining average demand for digital space for a unit of time by executing the availability query on historical data;
determining a quantity of available digital space during the predetermined period based on the average demand for digital space for the unit of time and the respective quantity of available digital space for the at least one base query; and
transmit the quantity of available digital space to the user device via the application programming interface.

16. The non-transitory computer-readable medium of claim 15, wherein the instructions cause the at least one device to perform operations comprising determining a correlation factor based on an average demand for digital space for the unit of time calculated for a query of the availability request and average demand for digital space for the unit of time calculated for the at least one base query.

17. The non-transitory computer-readable medium of claim 15, wherein executing the at least one base query on historical data comprises performing stratified sampling of the historical data to evaluate the query.

18. The non-transitory computer-readable medium of claim 15, wherein the instructions cause the at least one device to perform operations comprising determining an expected quantity of selected digital space using the quantity of available digital space during the predetermined period for the at least one base query and a selection probability for the predetermined period.

19. The non-transitory computer-readable medium of claim 15, wherein the respective quantity of available digital space for the at least one base query is determined at a first time based on usage trends determined at a first time.

20. The non-transitory computer-readable medium of claim 19, wherein the usage trends are determined using a plurality of time-series models.
